(19) United States
(12) Patent Application Publication
(10) Pub. No.: US 2026/0302446 A1
(43) Pub. Date: Oct. 1, 2026

(54) AIR BATTERY

(71) Applicant: HONDA MOTOR CO., LTD., Tokyo (JP)

(72) Inventors: Yugo TAKASHIMA, Wako-shi (JP); Chiaki SEKI, Wako-shi (JP)

(21) Appl. No.: 19/558,932

(22) Filed: Mar. 6, 2026

(30) Foreign Application Priority Data
Mar. 25, 2025 (JP) 2025-049368

(51) Int. Cl. H01M 50/148; H01M 12/02; H01M 12/08

(52) U.S. Cl. CPC H01M 50/1537; H01M 12/02; H01M 12/08

(57) ABSTRACT

An air battery is provided that not only suppresses liquid shortage but also maintains output characteristics. The air battery of the present disclosure includes a cathode, an anode, and an electrolyte provided between the cathode and the anode. The air battery further includes a cover facing an outer surface of the cathode in contact with air. Herein, a minimum value of an interval between the outer surface and the cover is 0.5 to 10 mm, and preferably 1 to 2 mm.

### CROSS-REFERENCE TO RELATED APPLICATION

This disclosure claims the priority benefit of Japanese Patent Application No. 2025-049368 filed on Mar. 25, 2025, and the entirety of the above-mentioned patent application is hereby incorporated by reference herein and made a part of this specification.

### TECHNICAL FIELD

The present disclosure relates to an air battery.

### BACKGROUND ART

Recently, research and development have been conducted on a secondary battery that contributes to energy efficiency so that more people can ensure access to affordable, reliable, sustainable, and advanced energy.

An air battery using oxygen in the air as a cathode active material and using a metal as an anode active material has been mainly used as a primary battery.

However, since the air battery has a very high energy density, the air battery is expected not only as a primary battery but also as a next-generation secondary battery. Therefore, research and development thereof have been advanced from various viewpoints.

For example, in Japanese Unexamined Patent Application Publication No. 2017-168312 (Patent Document 1), it is proposed that a metal-air battery configured to include a cathode for discharge and a cathode for charge both of which are air electrodes, an anode which is a metal electrode, and an electrolyte solution. Herein, in the cathode for charge, a surface thereof facing the electrolyte solution and a surface thereof facing the outside air are respectively in contact with separators. The separator in contact with the surface facing the outside air has a higher air permeability than the separator in contact with the surface facing the electrolyte solution.

### SUMMARY OF THE DISCLOSURE

In the air battery disclosed in Patent Document 1, providing a separator on a surface of the cathode facing the outside air suppresses “liquid shortage” in which an amount of the electrolyte decreases.

However, in the configuration of Patent Document 1, the air supplied to the cathode is blocked by the separator, and the air is hardly taken in, so that there is a risk that the “output characteristics”, which is a very important index for the air battery, may be deteriorated.

As a measure against liquid shortage of the air battery, a method for gelling the electrolyte is also exemplified. However, when the electrolyte is gelled, the ion transfer resistance increases, and therefore, even in this method, there is a risk that the “output characteristics” may decrease.

Accordingly, an object of the present disclosure is to provide an air battery capable of not only suppressing liquid shortage but also maintaining output characteristics, resulting in contribution to energy efficiency.

For achieving the above-mentioned object, the air battery of the present disclosure includes a cathode, an anode, an electrolyte provided between the cathode and the anode. Further, the air battery includes a cover facing an outer surface of the cathode in contact with air. Herein, a minimum value of an interval between the outer surface and the cover is 0.5 to 10 mm.

According to the air battery of the present disclosure, it is possible not only to suppress liquid shortage but also maintain output characteristics. As a result, this feature contributes to energy efficiency.

### BRIEF DESCRIPTION OF THE DRAWINGS

FIG. 1 is a cross-sectional view of an air battery according to the present embodiment.

FIG. 2 is a table showing conditions of a charge and discharge device in a 0.6V termination-current density test.

FIG. 3 is a table showing conditions of a charge and discharge device in a cycle test.

FIG. 4 is a graph showing results of a 0.6V termination-current density test and results of a cycle test.

### DESCRIPTION OF EMBODIMENTS

Hereinafter, embodiments (i.e., present embodiment) for carrying out an air battery according to the present disclosure will be described.

### [Air Battery]

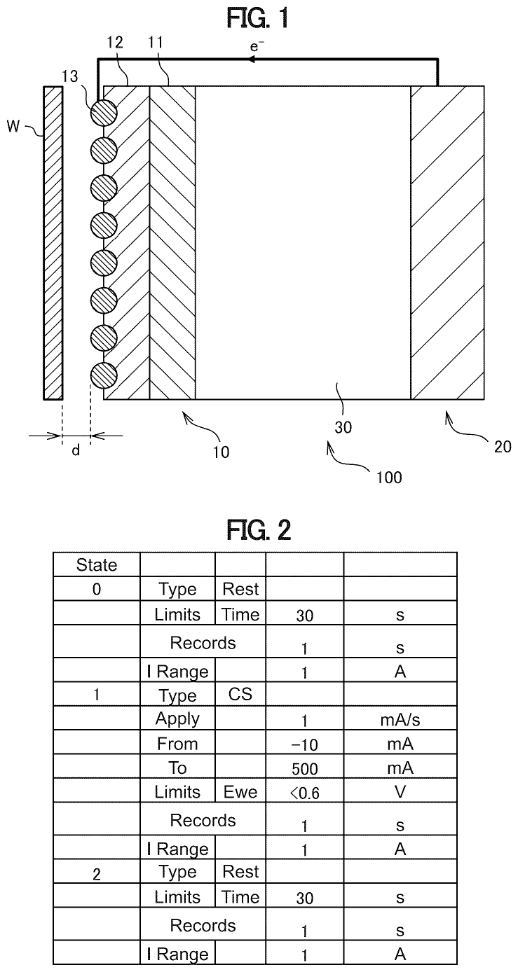

An air battery according to the present embodiment is an air battery that is a secondary battery, and is also referred to as a metal-air battery. As shown in FIG. 1, the air battery 100 includes a cathode 10, an anode 20, and an electrolyte 30 provided therebetween. The air battery 100 includes a cover W facing an outer surface (i.e., a surface facing the outside air) of the cathode 10 in contact with air.

The present inventors have made intensive studies on the structure of the air battery 100. As a result, the inventors have found that both “suppression of liquid shortage” and “maintenance of output characteristics” can be achieved by adjusting an interval d (also referred to as an airway width) between the cathode 10 and the cover W.

Hereinafter, each member configuring the air battery according to the present embodiment will be described in detail with reference to FIG. 1.

### (Cathode)

The cathode 10 is an electrode using oxygen in the air as a cathode active material, and is therefore also called an air electrode. The cathode 10 includes an electrode reaction layer 11, a gas supply layer 12, and a current collector 13.

### (Cathode: Electrode Reaction Layer)

The electrode reaction layer 11 is a layer in which an electrochemical reaction of “4OH⁻→O₂+2H₂O+4e⁻” occurs during charge, and an electrochemical reaction of “O₂+2H₂O+4e⁻→4OH⁻” occurs during discharge.

The electrode reaction layer 11 may be composed of a single layer as shown in FIG. 1, or may be composed of a plurality of layers.

In the case where the electrode reaction layer 11 is a single layer, the electrode reaction layer 11 may contain a substance that exhibits activity of an oxygen evolution reaction (OER) during charge as well as activity of an oxygen reduction reaction (ORR) during discharge. The substance exhibiting both OER activity and ORR activity include, for example, conductive carbon materials, and specifically include graphene, Ketjen black, and acetylene black, and the like.

When the electrode reaction layer 11 is composed of a plurality of layers, a first electrode reaction layer containing a substance that exhibits OER activity during charge and a second electrode reaction layer containing a substance that exhibits ORR activity during discharge may be stacked. The substance exhibiting OER activity includes ABO₃ metal oxides (perovskite oxides represented by the chemical composition ABO₃), where A is one or more of La, Pr, Ca, Sr, and Ba, and B is one or more of Mn, Ni, Fe, Co, Cu, and Cr. Specifically, the metal oxides include LaNiO₃, LaMnO₃, LaCoO₃, LaCrO₃, LaFeO₃, and the like.

Further, the substance exhibiting ORR activity includes conductive carbon materials such as graphene, Ketjen black, and acetylene black, which are exemplified as the substance exhibiting both OER activity and ORR activity.

Note, a method for producing the conductive carbon material and the metal oxide is not particularly limited, but is, for example, as follows.

The conductive carbon material can be produced by a mechanochemical method. The mechanochemical method is a material synthesis method based on a chemical change (i.e., mechanochemical reaction) utilizing mechanical energy such as collision energy or shear energy. Examples thereof include a method using a planetary ball mill provided with a stainless steel ball having a large diameter as a mechanical energy source.

The metal oxide can be synthesized by a reverse homogeneous precipitation method. The reverse homogeneous precipitation method is conducted by adding a small amount of an aqueous solution of metal ions dropwise to a large amount of an aqueous solution having a high pH, thereby rapidly changing a pH of the aqueous solution and simultaneously precipitating plural types of metal ions having different solubility products as hydroxides. As a result, according to the reverse homogeneous precipitation method, fine particles of metal hydroxides having high homogeneous mixing properties of plural types of metal ions can be synthesized.

### (Cathode: Gas Supply Layer)

A gas supply layer 12 is a layer that supplies gas (air) supplied from the outside to an electrode reaction layer 11. The gas supply layer 12 also serves as a water repellent layer and suppresses evaporation of an electrolyte.

The gas supply layer 12 is not particularly limited as long as it is a porous layer capable of diffusing gas. The gas supply layer 12 may be configured with a conventionally known material such as hydrophobic carbon (e.g., acetylene black), carbon black, or carbon paper.

### (Cathode: Current Collector)

A current collector 13 is a current collector on the cathode side and is a conductor that collects electricity.

The current collector 13 is not particularly limited as long as it is a substance capable of collecting current. The current collector 13 may be made of a conventionally known material such as nickel, iron, or titanium. Further, the current collector 13 is preferably in a mesh shape (i.e., network shape) in order to ensure ventilation from the outside to the electrode reaction layer 11.

### (Cover)

A cover W is a member provided so as to face an outer surface of the cathode 10 that is in contact with air. A flow path (i.e., airway) through which air flows is formed between the cover W and the cathode 10.

In FIG. 1, the cover W is provided only at a place facing the outer surface of the cathode 10, but the cover W may be a part of a housing surrounding the entire of cathode 10, anode 20, and electrolyte 30. However, the housing is provided with a vent capable of taking external air into the inside so that air flows between the cathode 10 and the cover W.

### (Relationship Between Cathode and Cover)

The present inventors have conducted intensive studies on an interval d between the outer surface of the cathode 10 and the cover W. As a result, the present inventors have confirmed that, when the interval d is large, a supply of air (i.e., oxygen) to the cathode 10 is appropriately performed, and output characteristics are reliably exhibited. However, the electrolyte is likely to evaporate from the outer surface of the cathode 10, and liquid shortage of the electrolyte occurs. On the other hand, the present inventors have confirmed that when the interval d is small, the liquid shortage of the electrolyte can be suppressed, but the air is not sufficiently supplied to the cathode 10, and the output characteristics cannot be maintained. The details are described as follows.

A minimum value of the interval d between the outer surface of the cathode 10 and the cover W is preferably 0.5 to 10 mm, more preferably 1 to 7.5 mm, 1 to 5 mm, or 1 to 2 mm. Further, all the intervals d between the outer surface of the cathode 10 and the cover W are preferably 0.5 to 10 mm, more preferably 1 to 7.5 mm, 1 to 5 mm, and 1 to 2 mm.

As described above, setting the minimum value of the interval d or all the intervals d to be within a predetermined range enables both “suppression of liquid shortage” and “maintenance of output characteristics” to be achieved.

Note, the interval d is, specifically, a distance from an inner surface of the cover W (i.e., a surface facing the cathode) to an outer surface of the cathode 10 (i.e., a surface facing the air) in a vertical direction

The interval d between the outer surface of the cathode 10 and the cover W is preferably constant. When the interval is constant, the air can flow smoothly between the cathode 10 and the cover W, and thus stability of the electrochemical reaction is excellent. Here, “constant” means that the outer surface of the cathode 10 and the inner surface of the cover W are provided so as to be parallel to each other, and all the intervals d are substantially the same, and specifically, means a state in which the maximum difference in the intervals d is within 0.01 mm.

### (Anode)

An anode 20 may be made of a conventionally known metal material used for an air battery, for example, including zinc, lithium, aluminum, magnesium, and iron, and zinc is particularly preferable. The anode 20 may be configured so that a surface of a carbon-based material or the like is plated with such a metal material.

Further, when zinc is used for the anode, reactions such as “Zn+4OH⁻→Zn(OH)₄²⁻+2e⁻”, “Zn(OH)₄²⁻→ZnO+H₂O+2OH⁻”, and “Zn(OH)₄²⁻→ZnO₂²⁻+2H₂O” occur during discharge.

Note, when the anode 20 includes a current collector, the current collector may be made of a conventionally known material used as a current collector, for example, including stainless steel (SUS) plated with gold, nickel, and titanium.

### (Electrolyte)

An electrolyte 30 may also be a conventionally known electrolyte used in an air battery. However, from the viewpoint of excellent ion conductivity and from the viewpoint of clarifying the problem of liquid shortage, a liquid electrolyte such as an aqueous electrolyte or a nonaqueous electrolyte is preferred. The aqueous electrolyte includes, for example, an aqueous potassium hydroxide (KOH) solution, an aqueous sodium hydroxide (NaOH) solution, and an aqueous ammonium chloride (NH₄Cl) solution.

### (Other Configurations)

The air battery according to the present embodiment may include, in addition to the cathode, the anode, and the electrolyte described above, conventionally known components provided in an air battery. For example, the air battery includes a separator for suppressing deposition of dendrites, a fan for supplying air to the cathode, a filter for removing carbon dioxide (CO₂), and the like.

The air battery according to the present embodiment is not limited to a structure in which respective members (i.e., the cathode 10, the anode 20, and the electrolyte 30) are stacked in a plate shape as shown in FIG. 1. For example, the air battery may have a structure including a rod-shaped anode, a cylindrical cathode formed to surround the anode as a center at a predetermined interval, and an electrolyte filling a space between the anode and the cathode.

### (Effects of Air Battery)

The air battery according to the present embodiment is an air battery, including a cathode, an anode, and an electrolyte provided between the cathode and the anode. The air battery further includes a cover facing an outer surface of the cathode in contact with air, and a minimum value of an interval between the outer surface and the cover is 0.5 to 10 mm.

According to the present embodiment, since the minimum value of the interval between the outer surface of the cathode and the cover is within the predetermined range, evaporation of electrolytes from the outer surface of the cathode can be suppressed, and a decrease in current densities at a 0.6V termination voltage can be suppressed. This feature can both suppress the liquid shortage and maintain the output characteristics.

In the air battery according to the present embodiment, the minimum value of the interval is preferably 1 to 2 mm.

According to the present embodiment, since a liquid volume retention rate after 50-cycle test can be 75% or more, the suppression of liquid shortage can be more strongly performed.

In the air battery according to the present embodiment, all the intervals between the outer surface and the cover preferably fall in 0.5 to 10 mm.

According to the present embodiment, it is possible to more surely exert the desired effects (i.e., suppression of liquid shortage and maintenance of output characteristics).

In the air battery according to the present embodiment, the interval between the outer surface and the cover is preferably constant.

According to the present embodiment, the air flow between the cathode and the cover can be made smooth, and therefore, the stability of the electrochemical reaction is excellent.

In the air battery according to the present embodiment, the electrolyte is preferably a liquid.

According to the present embodiment, it is possible to have the ion conductivity be excellent, and improve the output characteristics of the air battery.

### EXAMPLES

Next, the present disclosure will be described by showing Examples satisfying requirements of the present disclosure and Comparative Examples not satisfying the requirements of the present disclosure.

### [Sample Preparation Procedure]

A procedure for preparing a sample is as follows.

### (Synthesis of Graphene by Mechanochemical Method)

A graphite powder (FUJIFILM Wako Pure Chemical Corporation, 072 to 03845) was ground for 2 hours in a 700 rpm under an argon atmosphere using a planetary ball mill (P-7 manufactured by Fritsch Japan Co., Ltd.), thereby synthesizing graphene.

Then, a resulting ground sample was collected and stirred in 5% hydrochloric acid for 12 hours or more to remove stainless steel mixed therein, thereby obtaining graphene.

### (Production of Cathode)

First, graphene obtained by a mechanochemical method and a PTFE aqueous dispersion (DAIKIN INDUSTRIES, LTD., polyflon PTFE D-210C) were added to a mixture of a dispersing agent (1-butanol) and distilled water, and the mixture was stirred for 10 minutes. Then, the mixture was collected by vacuum filtration, and ground by a mixer to obtain a carbon material powder.

Next, hydrophobic carbon (Denka Li-100) and a PTFE aqueous dispersion were added to a mixture of distilled water and a nonionic surfactant (TritonX-100 (Kishida Chemical Co., Ltd.)), and the mixture was stirred for 10 minutes. The mixture was collected by suction filtration, and ground by a mixer to prepare a powder of a gas supply layer.

Ni mesh (NI-318100, Nilaco Corporation) having a size of F 24 mm and the powder of gas supplying layer were stacked on the mold, and pressed at 1 MPa, and a carbon material powder was stacked, and pressed at 2.5 GPa. Thereafter, the mold was heated to the melting temperature of PTFE (365° C.), and then immediately pressed at 5 GPa and rapidly cooled to obtain a cathode (F 24 mm, thickness: about 1 mm).

### (Other Configuration of Each Sample Used in Each Test)

In each test, the cathode obtained by the above-described production method was used, and an air battery 100 having the configuration shown in FIG. 1 was prepared.

Specifically, the cathode 10 was a cathode obtained by the above-described production method, utilizing a stack of the electrode reaction layer 11, the gas supply layer 12, and the current collector 13. A zinc plate was used as the anode 20, and stainless steel (SUS) plated with gold was used as a current collector (not shown) provided on the outer surface of the anode 20. Further, an aqueous solution of potassium hydroxide (KOH) was used as the electrolyte 30. Note, an effective area of the electrodes of the air battery 100 was 2 cm².

Then, a plastic cover W was provided on the air battery 100 so that the interval d had a value as shown in Tables 1 and 2.

Although a thickness of the current collector 13 was about 0.2 mm, most of the current collector 13 was buried in the gas supply layer 12, and the interval d between the outer surface of the cathode 10 and the cover W in each sample was constant (i.e., the maximum difference in the intervals d was within 0.01 mm).

As a charge and discharge device for charging and discharging the air battery 100, VMP-300 manufactured by Bio-Logic Corporation was used.

In the following respective tests, a constant amount of air was always sent between the outer surface of the cathode 10 and the cover W by a fan during the tests of all the samples, unless otherwise specified.

### (0.6V Termination-Current Density Test)

Conditions of a 0.6V termination-current density test were set as shown in FIG. 2.

Specifically, as shown in FIG. 2, State 0→State 1 (discharge)→State 2 processes were performed, and current densities at 0.6V termination voltage in State 1 were measured. Note, a sweep range of the current density was 0-250 mA/cm².

It can be determined that the higher the current densities at 0.6V termination voltage (mA/cm²)”, the more the output characteristics are maintained.

### (Cycle Test: Conditions of Charge-Discharge)

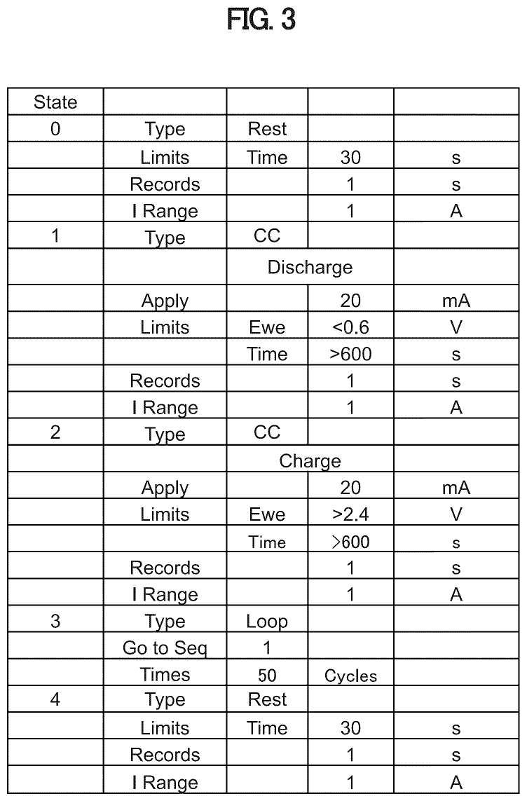

The charge-discharge conditions in the cycle test were as shown in FIG. 3.

Specifically, as shown in FIG. 3, a cycle of discharge and charge, that is, after conducting State 0→State 1 (discharge)→State 2 (charge), then returning to State 1 at State 3, and conducting State 1→State 2, was repeated 50 times. Note that, although the cycle test was set to be ended by shifting to State 4 at the timing when the voltage became lower than 0.6V in State 1, all the samples were repeatedly discharged and charged 50 times.

A mass of the air battery of each sample (excluding the cover) was measured before and after the cycle test, and the “liquid volume retention rate (%) after 50cyc.” (=mass of air battery after cycle test/mass of air battery before cycle test×100) was calculated.

It can be determined that the higher the “liquid volume retention rate (%) after 50cyc.” is, the more the liquid shortage is suppressed.

The following table shows an airway width of each sample and test results of each test.

TABLE 1

| Sample No. | 1 | 2 | 3 | 4 | 5 | 6 | 7 |
|---|---|---|---|---|---|---|---|
| Interval between Outer | 0 | 0.5 | 1 | 2 | 5 | 10 | Open* |
| Surface of Cathode and | | | | | | | |
| Cover = Airway | | | | | | | |
| Width (mm) | | | | | | | |
| 0.6V Termination- | 50 | 183 | 197 | 220 | 220 | 220 | 214 |
| Current Density | | | | | | | |
| (mA/cm²) | | | | | | | |
| Liquid Volume | 97 | 90 | 98 | 75 | 72 | 74 | 50 |
| Retention Rate | | | | | | | |
| after 50 cyc. (%) | | | | | | | |

*Open: Provided with no cover

### (Examination of Results)

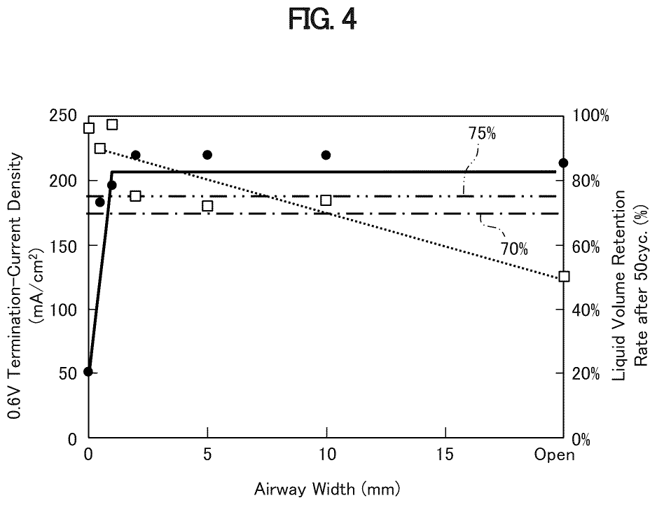

FIG. 4 shows results of the 0.6V termination-current density test and results of the cycle test.

In FIG. 4, “● (plotted with a black circle)” indicates the results of the current densities (mA/cm²) at the 0.6V termination voltage, and “□ (plotted with a hollow square)” indicates the results of the liquid volume retention rates (%) after the 50-cycle test. Further, the dotted line in FIG. 4 is an approximate straight line of the liquid volume retention rate, and the solid line is a line drawn by the present inventors in order to facilitate understanding of the tendency of the results of the current density.

Based on the results of Table 1 and FIG. 4, it was confirmed that both “suppression of liquid shortage” and “maintenance of output characteristics” can be achieved by specifying the interval between the cathode and the cover (i.e., the airway width) within a predetermined range

Specifically, the alternate long and short dash line in FIG. 4 indicates a reference line of the liquid volume retention rate of 70%, and all the samples having airway widths equal to or less than 10 mm were located above the alternate long and short dash line. The airway width at the intersection part of the dotted line which is an approximate straight line of the liquid volume retention rate and the one dot chain line was 10 mm. Therefore, it was confirmed that the liquid volume retention rate can be 70% or more, in other words, the liquid shortage can be suppressed by setting the airway width to equal to or less than 10 mm.

Further, the two dot chain line in FIG. 4 indicates a reference line at which the liquid volume retention rate is 75%, and all the samples having airway widths equal to or less than 2 mm were located above the two-dot chain line. Therefore, it was confirmed that the liquid volume retention rate can be 75% or more, in other words, the liquid shortage can be more strongly suppressed by setting the airway width to equal to or less than 2 mm.

Further, according to Table 1 and FIG. 4, it was confirmed that the current densities at the 0.6V termination voltage are increased and the output characteristics are maintained when the airway widths are 0.5 mm or more, and further 1 mm or more.

### REFERENCE SIGNS LIST

10 cathode
11 electrode reaction layer
12 gas supply layer
13 current collector
20 anode
30 electrolyte
100 air battery

What is claimed is:

1. An air battery comprising:
a cathode,
an anode,
an electrolyte provided between the cathode and the anode, and
a cover facing an outer surface of the cathode in contact with air, wherein
a minimum value of an interval between the outer surface and the cover is 0.5 to 10 mm.

2. The air battery according to claim 1, wherein a minimum value of the interval is 1 to 2 mm.

3. The air battery according to claim 1, wherein all intervals between the outer surface and the cover fall in 0.5 to 10 mm.

4. The air battery according to claim 1, wherein the interval between the outer surface and the cover is constant.

5. The air battery according to claim 2, wherein the interval between the outer surface and the cover is constant.

6. The air battery according to claim 1, wherein the electrolyte is a liquid.

7. The air battery according to claim 2, wherein the electrolyte is a liquid.
